(19) United States
(12) Patent Application Publication
(10) Pub. No.: US 2020/0168043 A1
(43) Pub. Date: May 28, 2020

(54) Distributed Promotional Coupon System with Real-Time Activity Monitoring

(71) Applicant: JCM American Corporation, Las Vegas, NV (US)

(72) Inventor: Eric Meyerhofer, Las Vegas, NV (US)

(21) Appl. No.: 16/777,788

(22) Filed: Jan. 30, 2020

Related U.S. Application Data
(63) Continuation of application No. 12/161,788, filed on Apr. 6, 2009.
(60) Provisional application No. 60/761,575, filed on Jan. 23, 2006.

(51) Int. Cl. G07F 17/32; G06Q 30/02

(52) U.S. Cl. CPC G07F 17/3248; G06Q 30/0209; G07F 17/32

(57) ABSTRACT

Methods and apparatuses for a distributed promotional coupon system for use within a casino which has cash-less gaming machines involving a plurality of game installed cash-out vouchers printers networked to a central server. The system can provide promotions to all patrons of a casino, either through player tracking or anonymously. The system provide a means for the creation and issuance of promotional coupons as well as the tracking of the redemption of such coupons, real-time monitoring of a gaming printer's activities, connecting to other existing systems in a casino, such as an accounting system or point-of-sale system. Additionally, such a system may use existing equipment such as a gaming printer to produce such coupons, however, only after the existing equipment produces a cash-out voucher.

### CROSS-REFERENCE TO RELATED APPLICATIONS

The present application claims the benefit us U.S. Provisional Application No. 60/761,575 filed Jan. 23, 2006, the contents of which are incorporated by reference as if stated in full herein.

### BACKGROUND OF THE INVENTION

This invention relates generally to printers and printer connected hardware used in cash-less slot machines and gaming, and more specifically to hardware and software operating within this equipment performing promotional ticket printing, promotional data basing and printer and printer connected hardware based promotional ticket triggering.

The gaming machine manufacturing industry provides a variety of gaming machines for the amusement of gambling players. An exemplary gaming machine is a slot machine. A slot machine is an electro-mechanical game wherein chance or the skill of a player determines the outcome of the game. Slot machines are usually found in casinos or other more informal gaming establishments.

The gaming machine manufacturers have provided cash-less enabled games to the market for the last five year, and there now exists a broad population of such games in the casino industry. Cash-less enabled games are so named due to the fact that they can conduct their player's financial exchange with a mixture of traditional paper and coin currency and vouchers redeemable for cash or game credits.

Two pieces of necessary equipment for a cash-less enabled game is a printer to produce the vouchers, and a bill acceptor that supports automatic reading of the vouchers. In a cash-less enabled gaming system, when a player cashes out, the game is signaled and depending on the size of the pay out, it can either present coins in the tradition method of a slot machine, or it can cause the printers which are installed in such machines to produce a voucher containing the value of the pay out. The voucher may then either be redeemed for cash at the cashier's cage for currency, or it may be inserted into one of the casino's games' bill acceptor, at which point the network and server to which the game is connected will recognize the voucher as valid, redeem it and place the appropriate amount of playing credits on the game.

Over the last five years, cash-less enabled games have found an increasing acceptance and use in the gaming industry with both the players, who enjoy the speed of play and ease of transporting their winnings around the casino, and the casinos who have realized significant labor savings in the form of reduced coin hopper reloads in the games, and an increase in revenue due to speed of play. The broad installation base of cash-less enabled games guarantees a wide installed base of networked games and their installed printers which may be used to print coupons and promotions for the captive player audiences.

Currently, in typical casino operations, the games are networked to a main server which monitors various metrics of activity on the games for regulatory, accounting and promotional activities. The server related to promotions for player club cards is referred to as the Player Tracking Sever. Games share real-time play metrics with the Player Tracking Server in order to support frequent player incentives.

One of the problems that exist with the current situation is how to offer promotions to patrons who are not part of the player tracking system, either by the patron's choice for anonymity or a casino's lack of use of a player tracking system.

Therefore, one solution is to provide a system which can provide promotions to all patrons of a casino. Further, it would be advantageous to provide a means for the creation and issuance of promotional coupons as well as the tracking of the redemption of such coupons; to provide real-time monitoring of a gaming printer's activities; for connecting to other existing systems in a casino, such as an accounting system or point-of-sale system. Additionally, such a system may use existing equipment such as a gaming printer to produce such coupons, however, only after the existing equipment produces a cash-out voucher.

The methods and apparatus of the present invention provide the foregoing and other advantages.

### Definitions

For the purposes of this document the following definitions apply:

“PCS”—Acronym for Promotional Coupon System. This is the system which is responsible for creating and managing promotional coupons in the gaming environment.

“GVP”—Acronym for Game Installed Voucher Printer. This is the printer attached to a slot machine, gaming machine, gaming table, or casino installed kiosk whose primary responsibility is the printing of cash-out vouchers.

“Gaming Machine”, “Game Machine”, “Game”—A slot machine, gaming machine, or game table in a casino.

“Cash-out Voucher System”—The system installed in a casino used to create cash-out voucher records and issue data packages to gaming machines which will cause it to print a cash-out voucher. A Cash-out Voucher System is a rudimentary part of the existing casino industry architecture for casinos supporting cashless gaming.

“Point-of-sale system”—The system installed in a casino at various locations where business in the casino is transacted, such as a retail shop, restaurant, ticket sales counter, front desk, etc.

“Coupon Trigger Metrics”—As defined in the body of the document.

“Coupon Issuance Control Parameters”—As defined in the body of the document.

“PSP”—Acronym for Player Session Packet. As defined in the body of the document.

### SUMMARY OF THE INVENTION

In one aspect of the invention, a promotional coupon system includes a central data processing unit such as a network server (“PCS”), a plurality of game machines, each game machine including a Game Installed Voucher Printer (“GVP”), each GVP coupled through a primary communication port to the controller of the game machine into which it is installed, each GVP further coupled to central data processing unit through an second auxiliary port, each GVP further coupled to a third auxiliary port, the GVP receiving signaling for cash-out vouchers through the primary communications port, signaling for promotional coupons through the second auxiliary port, and signaling for real-time printer activity monitoring through the third auxiliary port.

In another aspect of the invention, a GVP is coupled to a multiplex input channel or port wherein the port processes signaling related to promotional coupons and the real-time monitoring of the printer activities.

In another aspect of the invention, a GVP is coupled to dedicated input channels or ports wherein one port processes signaling related to vouchers, a second port processes signaling related to promotional coupons, and a third port processes signaling related to the real-time monitoring of printer activities.

In another aspect of the invention, a GVP is coupled to a combination of multiplex and one or a plurality of dedicated input channels or ports wherein one dedicated port processes signaling related to vouchers, a second port processes signaling related to promotional coupons, and a third port processes signaling related to the real-time monitoring of printer activities, wherein the second and third ports may be a multiplexer port.

In another aspect of the invention, a GVP using an auxiliary port and interface plugs into a game machine where the printer may receive and transmit real-time activity data to a PCS, gaming machine, or other host system.

In another aspect of the invention, a PCS polls a game machine or GVP for information, the information may include trigger metrics as disclosed below.

In another aspect of the invention, a GVP receives and responds to signaling from a host system such as a PCS, the signaling is a trigger which causes the GVP to process a request from the host system.

In another aspect of the invention, a PCS monitors in real-time the printer activities wherein the PCS signals one or multiple GVPs for the printer's activities, and the GVP responds to the signaling.

In another aspect of the invention, the printer activities requested from the PCS and reported by a GVP may include any promotional coupon activity performed by the GVP including any “Coupon Trigger Metrics”, any “Coupon Issuance Control Parameter” both of which are disclosed below, number of promotional coupons printed, number of times a template was used to produce a promotional coupon, among others.

In another aspect of the invention, the printer activities requested from the PCS and reported by a GVP may include any voucher activity performed by the GVP including a cash-out request by a player, number of vouchers printed, and number of times a template was used to produce a voucher, among others.

In another aspect of the invention, the printer activities requested from the PCS and reported by a GVP may include other printer activity such as any printing error, if printer is busy, if paper out, low, or jammed, temperature or voltage condition, data error, memory error, printer online or offline, printer in sleep mode, printer door open, any power reset, historical data on the print head, print job failed, or print job completed, among others,

In another aspect of the invention, the real-time printer activities reported by a GVP coupled to a PCS may include a date/time stamp, GVP unique ID, among others.

In another aspect of the invention, data collected during the real-time monitoring of printer activity of one or multiple GVPs and reported to a PCS by a GVP may be used in combination with other data for reporting purposes whereby the PCS may, for example, use a date/time stamp associated with template data in combination with procedures to determine if the template in a GVP matches template data in the PCS. If the template data does not match, the PCS sending the appropriate template data to the GVP.

In another aspect of the invention, the PCS transmits to one or a plurality of GVPs unsolicited data, the unsolicited data may include data related to promotional coupons such as template to use, a new template definition, and any static or variable data to use in producing coupons (disclosed below), among others.

In another aspect of the invention, the PCS transmits to one or a plurality of GVPs unsolicited data, the unsolicited data may include player game activity as a Player Session Packet (“PSP”), wherein the PSP may contain data that may indicate how much a player bet on a particular game, amount won or lost, amount of win, amount of money deposited into a game machine, if a player is cashing out, among others, the PSP may include trigger metrics and/or control parameters as disclosed below.

In another aspect of the invention, a GVP receives from the PCS unsolicited data, the unsolicited data may include that previously disclosed such as a PSP, the GVP in turn processing the PSP to determine if a coupon trigger was met in order to generate a promotional coupon.

In another aspect of the invention, the PSP may or may not include player identification information from a player tracking system.

In another aspect of the invention, the PCS includes a coupon trigger database which may contain various play metrics that may cause the PCS to request a GVP to produce a promotional coupon when satisfied, the metrics including the following among others and herein referred to as “Coupon Trigger Metrics”:
(a) anytime a cash-out voucher is printed;
(b) a cash-out voucher for greater than, equal to, or less than a specified amount of money is printed;
(c) the amount of money wagered over a particular time period;
(d) the amount of money won over a particular time period;
(e) the amount of money lost over a particular time period;
(f) the duration of play on the game;
(g) anytime a player adds money or credits to a game in an amount greater than, equal to, or less than a specified amount;
(h) the time when the game is is played or cashed-out;
(i) the day when a game is is played or cashed-out;
(j) the date when a game is is played or cashed-out;
(k) the average percentage of the maximum wagering on the game which the player's activity represents;
(l) a random percentage change that a coupon will be issued when a player cashes out;
(m) for participating frequent player club members, a player's birthday;
(n) for participating frequent player club members, the classification of the player is applied to modify any of the foregoing metrics.

In another aspect of the invention, a GVP receives from the PCS the Coupon Trigger Metrics, the GVP analyzes game activity passed to it by the PCS against the Coupon Trigger Metrics, and the GVP produces a promotional coupon when the metrics are satisfied.

In another aspect of the invention, a PCS includes a control parameters database which may select the type and quantity of promotional coupons to create and issue related to any of the Coupon Trigger Metrics, the control parameters operate separately or in combination with each coupon, the control parameters reside in and are utilized in procedures either on the PCS or a GVP or combination thereof, the control parameters including the following among others and herein referred to as “Coupon Issuance Control Parameters”:
(a) the total quantity of a coupon is issued before it is retired;
(b) the frequency of issuance of a coupon, one issued every time a specified number of trigger events occurs;
(c) the frequency of issuance of a coupon based on a random chance of one in every so many trigger events;
(d) an alternative coupon should a particular coupon fail to print for lack of satisfying all of its Coupon Trigger Metrics and/or its specified set of control parameters.

In another aspect of the invention, a GVP uses procedures, Coupon Trigger Metrics, and Coupon Issuance Control Parameters to produce a promotional coupon if metrics and parameters are satisfied.

In another aspect of the invention, a PCS uses promotional coupon data and procedures including the ways and means to send promotional coupon information to one or more coupled GVPs, the information is static data or variable data. The static data may contain various fixed portions of the printed indicia of promotional coupons which a GVP may use in the future creation of a promotional coupon, the static data may include one or a plurality of Coupon Trigger Metrics, one or a plurality of Coupon Issuance Control Parameters, a unique promotional campaign identifier, an authorization code, among others, the static data stored in the memory coupled to a GVP. The variable data may contain portions of printed indicia of promotional coupons or a unique promotional campaign identifier, an authorization code, among others, the variable data matched by a GVP to any variable data stored in the GVP's memory, the GVP combining portions of static and variable data to print a promotional coupon.

In another aspect of the invention, a GVP transmits an authorization code to a PCS, wherein the authorization code may be verified within the PCS, for example, to track promotional coupon redemption or retire a promotional coupon from issuance.

In another aspect of the invention, a GVP includes the ways and means to utilize arbitration in the printing of vouchers and promotional coupons, the GVP coupled to a PCS and a cash-out voucher system, both systems coupled to each other, wherein the GVP uses procedures contained in its memory and data or signaling from both or either system generates vouchers without delay and prior to any coupon is generated.

In another aspect of the invention, the plurality of GVPs are coupled to the PCS by a promotional network dedicated to the PCS-GVP connection, each GVP individually signaled by the PCS by means of a unique address.

In another aspect of the invention, the plurality of GVP's are coupled to the PCS by a promotional network dedicated to the PCS-GVP connection, each GVP is a sub-addressable device with the gaming machine available to the PCS.

In another aspect of the invention, the PCS, is coupled to the GVP on a dedicated PCS-GVP network, creating a logical link between the GVP's unique network address and the gaming machine into which the GVP is installed for the purposes of correlating the GVP's gaming machine identifier, the link created by the GVP extracting the gaming machine number from voucher data signaling from the gaming machine controller on its primary communication port, the GVP signaling the PCS with both its unique address and the extracted gaming machine number, and the PCS storing the link in its memory.

In another aspect of the invention, the PCS is coupled to the GVP on a dedicated PCS-GVP network, creating a logical link between the GVP's unique network address and the gaming machine into which the GVP is installed for the purposes of correlating the GVP's gaming machine identifier, the link created by the GVP reading operator configurable gaming machine identifier address switches coupled to the GVP's processor, the GVP signaling the PCS with both its unique address and the configured gaming machine identifier address, and the PCS storing the link in its memory.

In another aspect of the invention, the PCS, is coupled to the GVP on a dedicated PCS-GVP network, creating a logical link between the GVP's unique network address and the gaming machine into which the GVP is installed for the purposes of correlating the GVP's gaming machine identifier, the link created by the GVP is signaled as to its gaming machine identifier address by an operator controlled external device temporarily coupled to the GVP at the time the GVP is installed in a gaming machine, the GVP signaling the PCS with both its unique address and the operator controlled external device supplied gaming machine address, and the PCS storing the link in its memory.

In another aspect of the invention, the GVP is temporarily coupled to an operator controlled external device at the time the GVP is installed in a gaming machine, the GVP receiving signaling as to the gaming machine identifier address of the gaming machine into which it is installed, and the GVP storing the gaming machine identifier address into memory coupled to its processor.

In another aspect of the invention, the GVP signals the PCS as to the gaming machine identifier address in which it is installed upon boot-up or when requested by the PCS.

In another aspect of the invention, the GVP includes a procedure which, after boot-up, determines if a previously recorded gaming machine identifier exists in its memory, the identifier serving the purpose of signaling the GVP into which gaming machine it is installed, the procedure then signaling the PCS with the identifier.

In another aspect of the invention, the GVP's unique network address is configured by operator configurable address switches coupled to the GVP's processor.

In another aspect of the invention, the GVP's unique network address is assigned by the PCS, the GVP storing its address in memory for permanent use until a new address is assigned by the PCS.

In another aspect of the invention, the GVP stores the identification of the gaining machine identification into which it is installed into memory coupled to the GVP's processor.

In another aspect of the invention, the GVP's unique network address is a fixed value as a function of the GVP's hardware.

In another aspect of the invention, the GVP includes a procedure which causes the GVP, after boot-up, to first receive cash-out voucher signaling from the gaming machine over its primary port, and the GVP then verifying that the gaming machine identifier is the same as the gaming machine identifier previously recorded in its memory as to which gaming machine the GVP is installed.

In another aspect of the invention, the PCS broadcasts the time and date on a periodic basis to a GVP to which it is coupled, and the GVP uses the time and date data to synchronize its own internal clock.

In another aspect of the invention, the GVP upon receiving cash-out voucher signaling from the gaming machine over its primary port, extracts the time and date from the data and using the time and date information to synchronize its internal clock.

In another aspect of the invention, the GVP receives player activity data of the gaming machine in which it is installed from the PCS, the GVP processes the data according to procedures (disclosed below) contained in its memory, the GVP determines if a promotional award has been triggered by the player activity and the type of the award, the GVP signaling the PCS as to various metrics of the triggered promotional award, the PCS processes the metrics of the promotional award, the PCS operates a procedure to create a validation identifier for the promotional coupon, the PCS signals the GVP with data including the validation identifier and authorization to print the promotional coupon, the GVP prints the coupon, and the GVP signals the PCS as to the completion or failure of its print job.

In another aspect of the invention, the PCS having received the signaling from the GVP as to the completion or failure of a promotional award print job (disclosed above), and the PCS creating a record in its memory as to the issuance of the promotional coupon.

In another aspect of the invention, the PCS requests the GVP to send status as to the identifier of the promotional campaign static data file (described above) which resides in the GVP's memory, the PCS determining if the campaign identifier in the GVP is the version matches the identifier of the promotional campaign that the PCS is currently operating, and if not, the PCS sending new promotional campaign static data to the GVP which matches the promotional campaign which the PCS is operating.

In another aspect of the invention, the communications between the PCS and GVP is encrypted by a methodology known to the PCS and GVP, and the PCS and GVP processing incoming and outgoing communications according to the encryption method.

In another aspect of the invention, the PCS containing a record of promotional coupons issued by the GVPs in its memory, the PCS is coupled to a point-of-sale system, the PCS receiving signaling from the point-of-sale system when a coupon is redeemed as to the validation sequence of the coupon, the PCS checking the validity of the coupon against its records, the PCS signaling the point-of-sale system as to the validity of the coupon, and the PCS recording the redemption of the coupon in its memory.

In another aspect of the invention, the PCS is coupled to an accounting system, and the PCS transmitting data related to outstanding and redeemed promotional coupons from its database in memory.

In another aspect of the invention, the PCS storing data related to outstanding and redeemed promotional coupons from its database in memory.

In another aspect of the invention, the GVP receiving signaling from the PCS on its secondary auxiliary port to print a promotional coupon, the GVP holding the coupon data in its memory, the GVP receiving signaling from the gaming machine to which it is coupled on its primary port to print a cash-out voucher, the GVP printing the cash-out voucher, and when successfully completed, printing the coupon from the coupon data held in its memory.

In another aspect of the invention, the GVP receiving signaling from the PCS on its third auxiliary port for real-time monitoring of printer activities.

In another aspect of the invention, the GVP receiving signaling from the PCS related to promotional coupons and real-time monitoring of printer activities on a multiplex port.

In another aspect of the invention, the PCS is a player tracking system and its associated network.

In another aspect of the invention, the PCS is a player tracking system and its associated network receiving gaming machine activity data based on the PCS's monitoring of the gaming machine, the PCS utilizing its link table in memory (disclosed above) to determine the unique network address of the GVP installed in the gaming machine, and the PCS sending information extracted from the activity data to the GVP installed in the gaming machine.

In another aspect of the invention, the PCS is the player tracking system and its associated network receiving gaming machine activity data based on the PCS's monitoring of the gaming machine, the PCS processing the data according to procedures contained in its memory, the PCS determining if a promotional award has been triggered by the player activity, the PCS determining the type of award from a database in its memory, the PCS operating a procedure to create a validation identifier for the promotional coupon, the PCS signaling the GVP with data including the validation identifier and authorization to print the promotional coupon, the GVP printing such coupon, and the GVP signaling the PCS as to the completion of failure of its print job.

### BRIEF DESCRIPTION OF THE DRAWINGS

These and other aspects, aspects, and advantages of the present invention will become better understood with regard to the following description and accompanying drawings where:

FIG. 1 is an illustration of an exemplary connection of the PCS, a plurality of gaming machines, and a plurality of GVPs in accordance with an exemplary embodiment of the present invention.

FIG. 2 is an illustration of an automatic method by which the PCS can pair a GVP's IP address to a gaming machine identifier in accordance with an exemplary embodiment of the present invention.

FIG. 3 is an illustration of the PCS connected to other systems within a casino in accordance with an exemplary embodiment of the present invention.

FIG. 4 is an illustration of the trigger matrix logic and procedures with the GVP, the PCS, or portions shared between the two, depending on where data processing of the PSP resides in accordance with an exemplary embodiment of the present invention.

FIG. 5 is an illustration of arbitration process of a GVP in producing gaming vouchers and promotional coupons in accordance with an exemplary embodiment of the present invention.

FIG. 6 is an illustration depicting the real-time monitoring of printer activities by the PCS in accordance with an exemplary embodiment of the present invention.

FIG. 7 is an architecture diagram of a GVP in accordance with an exemplary embodiment of the present invention.

FIG. 8 is an architecture diagram of a PCS in accordance with an exemplary embodiment of the present invention.

### DETAILED DESCRIPTION

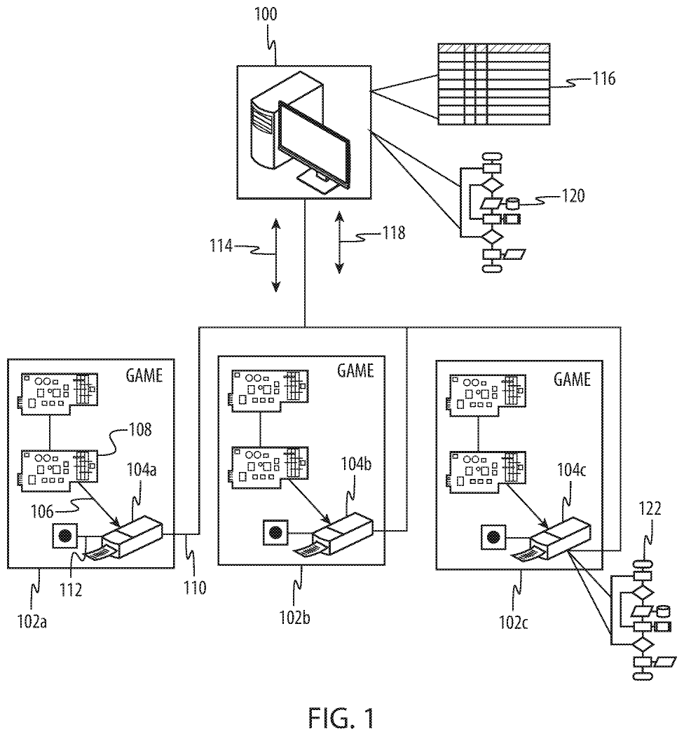

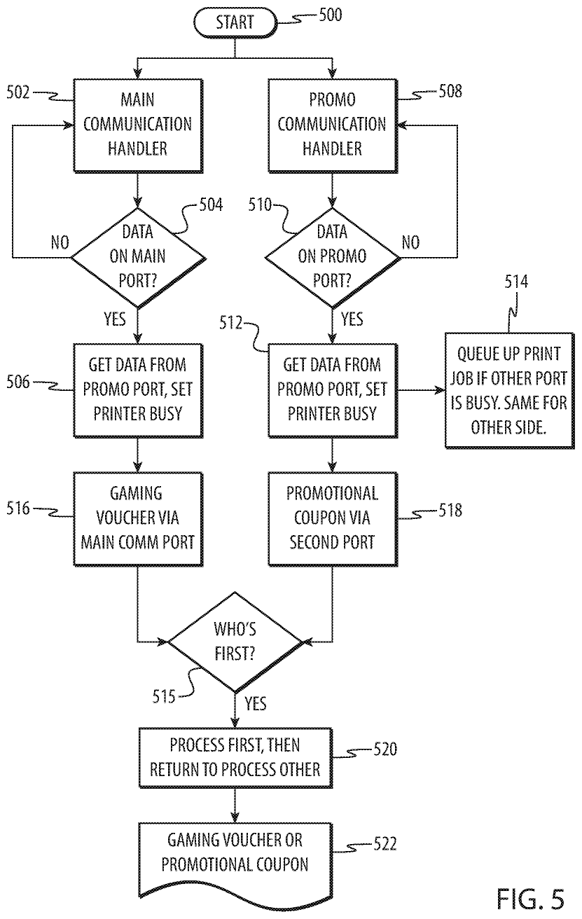

FIG. 1 is an illustration of an exemplary connection of a PCS, a plurality of gaming machines, such as gaming machines 102a, 102b and 102c, and a plurality of GVPs, such as GVPs 104a, 104b and 104c, in accordance with an exemplary embodiment of the present invention. The PCS as shown in the diagram, is a server who's responsibility is to direct the promotional activity of a GVP installed in a gaming machine. In an exemplary implementation, each GVP has three ports or channels; a primary port 106 connects the GVP to a controller 108 of the gaming machine in which the GVP is installed for cash-out vouchers, a second auxiliary port 110 for connection to the PCS for promotional couponing, and a third auxiliary port 112 for the real-time monitoring of printer activities. Each GVP has a unique address by which the GVP can specifically be selected. An Ethernet network would be an exemplary setup, where the GVP's address is an IP address on the network. One of the fundamental responsibilities of the GVP, considering that it has in essence two masters, one is the gaming machine controller and the other is the PCS, is arbitration of traffic on the two or more ports or channels as later discussed in FIG. 5. The complexity of this is increased since the two masters are operating asynchronously from each other.

Additionally, the PCS may be a player tracking system, distributed over a plurality of gaming machines and a plurality of GVPs connected in relation to each other. All the previous discussion applies, along with additional information. In this embodiment, the player tracking system receives information about player activity on a game to which it is connected. As used herein, data packets containing player gaming machine activity are referred to as Player Session Packets (“PSPs”) 114, and an example of the data would indicate that a player had bet so much on a particular game, had won or lost the bet, the amount of a win, the amount of money deposited in the machine, if a player was cashing out, and so on. The PCS, as a player tracking system, would determine by using procedures 120 and processing the packet which gaming machine the PSP originated from, look up from an internal database 116 which GVP IP address was related to that gaming machine, and forward the PSP to that IP address, essentially sending it to the GVP. The GVP using procedures would then process information from the PSP to determine if a coupon trigger condition is met. If a condition was met, the GVP informs the PCS of an award, requests a validation identifier or authorization 118 for the coupon, and obtains permission from the PCS to print the coupon. If approved, additional handshaking is conducted to ensure that the coupon was successfully produced, and the PCS then logs the validation number or authorization and the award type into the PCS's internal memory or database for later reconciliation.

In another embodiment of the invention, the PCS performs the analysis of the PSPs against a set of trigger conditions, and when a condition is met, the PCS signals the GVP with a coupon and a validation sequence for the coupon. Upon receipt of data from the PCS, the GVP produces the requested coupon. In this embodiment, handshaking applicable to the success/failure of the coupon print job is also conducted.

In another embodiment of the invention, a GVP uses a multiplexer port or channel instead of two dedicated ports. In this variation, signaling related to coupons and real-time printer activity monitoring is processed using a multiplexer port.

In another embodiment of the invention, a GVP is coupled to a multiplex input channel or port wherein the port processes signaling related to promotional coupons and the real-time monitoring of the printer activities.

In another embodiment of the invention, a GVP is coupled to dedicated input channels or ports wherein one port processes signaling related to vouchers, a second port processes signaling related to promotional coupons, and a third port processes signaling related to the real-time monitoring of printer activities.

In another embodiment of the invention, a GVP is coupled to a combination of multiplex and one or a plurality of dedicated input channels or ports wherein one dedicated port processes signaling related to vouchers, a second port processes signaling related to promotional coupons, and a third port processes signaling related to the real-time monitoring of printer activities, wherein the second and third ports may be a multiplexer port.

In another embodiment of the invention, a GVP using an auxiliary port and interface plugs into a game machine where the printer may receive and transmit real-time activity data to a PCS, gaming machine, or other host system.

In another embodiment of the invention, a PCS polls a game machine or GVP for information, the information may include trigger metrics as disclosed below.

In another embodiment of the invention, a GVP receives and responds to signaling from a host system such as a PCS, the signaling is a trigger which causes the GVP to process a request from the host system.

In another embodiment of the invention, a PCS monitors in real-time the printer activities wherein the PCS signals one or multiple GVPs for the printer's activities, and the GVP responds to the signaling.

In another embodiment of the invention, the printer activities requested from the PCS and reported by a GVP may include any promotional coupon activity performed by the GVP including any “Coupon Trigger Metrics”, any “Coupon Issuance Control Parameter” both of which are disclosed below, number of promotional coupons printed, number of times a template was used to produce a promotional coupon, among others.

In another embodiment of the invention, the printer activities requested from the PCS and reported by a GVP may include any voucher activity performed by the GVP including a cash-out request by a player, number of vouchers printed, and number of times a template was used to produce a voucher, among others.

In another embodiment of the invention, the printer activities requested from the PCS and reported by a GVP may include other printer activity such as any printing error, if printer is busy, if paper out, low, or jammed, temperature or voltage condition, data error, memory error, printer online or offline, printer in sleep mode, printer door open, any power reset, historical data on the print head, print job failed, or print job completed, among others,

In another embodiment of the invention, the real-time printer activities reported by a GVP coupled to a PCS may include a date/time stamp, GVP unique ID, among others.

In another embodiment of the invention, data collected during the real-time monitoring of printer activity of one or multiple GVPs and reported to a PCS by a GVP may be used in combination with other data for reporting purposes whereby the PCS may, for example, use a date/time stamp associated with template data in combination with procedures to determine if the template in a GVP matches template data in the PCS. If the template data does not match, the PCS sending the appropriate template data to the GVP.

In another embodiment of the invention, the PCS transmits to one or a plurality of GVPs unsolicited data, the unsolicited data may include data related to promotional coupons such as template to use, a new template definition, and any static or variable data to use in producing coupons (disclosed below), among others.

In another embodiment of the invention, the PCS transmits to one or a plurality of GVPs unsolicited data, the unsolicited data may include player game activity as a Player Session Packet (“PSP”), wherein the PSP may contain data that may indicate how much a player bet on a particular game, amount won or lost, amount of win, amount of money deposited into a game machine, if a player is cashing out, among others, the PSP may include trigger metrics and/or control parameters as disclosed below.

In another embodiment of the invention, a GVP receives from the PCS unsolicited data, the unsolicited data may include that previously disclosed such as a PSP, the GVP in turn processing the PSP to determine if a coupon trigger was met in order to generate a promotional coupon.

In another embodiment of the invention, the PSP may or may not include player identification information from a player tracking system.

In another embodiment of the invention, the PCS includes a coupon trigger database which may contain various play metrics that may cause the PCS to request a GVP to produce a promotional coupon when satisfied, the metrics including the following among others and herein referred to as “Coupon Trigger Metrics”:
(o) anytime a cash-out voucher is printed;
(p) a cash-out voucher for greater than, equal to, or less than a specified amount of money is printed;
(q) the amount of money wagered over a particular time period;
(r) the amount of money won over a particular time period;
(s) the amount of money lost over a particular time period;
(t) the duration of play on the game;
(u) anytime a player adds money or credits to a game in an amount greater than, equal to, or less than a specified amount;
(v) the time when the game is is played or cashed-out;
(w) the day when a game is is played or cashed-out;
(x) the date when a game is is played or cashed-out;
(y) the average percentage of the maximum wagering on the game which the player's activity represents;
(z) a random percentage change that a coupon will be issued when a player cashes out;
(aa) for participating frequent player club members, a player's birthday;
(bb) for participating frequent player club members, the classification of the player is applied to modify any of the foregoing metrics.

In another embodiment of the invention, a GVP receiving from the PCS the Coupon Trigger Metrics, the GVP analyzing game activity passed to it by the PCS against the Coupon Trigger Metrics, and the GVP producing a promotional coupon when the metrics are satisfied.

In another embodiment of the invention, a PCS including a control parameters database which may select the type and quantity of promotional coupons to create and issue related to any of the Coupon Trigger Metrics, the control parameters operating separately or in combination with each coupon, the control parameters residing in and is utilized in procedures either on the PCS or a GVP or combination thereof, the control parameters including the following among others and herein referred to as “Coupon Issuance Control Parameters”:
(e) the total quantity of a coupon is issued before it is retired;
(f) the frequency of issuance of a coupon, one issued every time a specified number of trigger events occurs;
(g) the frequency of issuance of a coupon based on a random chance of one in every so many trigger events;
(h) an alternative coupon should a particular coupon fail to print for lack of satisfying all of its Coupon Trigger Metrics and/or its specified set of control parameters.

In another embodiment of the invention, a GVP using procedures, Coupon Trigger Metrics, and Coupon Issuance Control Parameters to produce a promotional coupon if metrics and parameters are satisfied.

In another embodiment of the invention, a PCS using promotional coupon data and procedures including the ways and means to send promotional coupon information to one or more coupled GVPs, the information is static data or variable data. The static data may contain various fixed portions of the printed indicia of promotional coupons whereby a GVP may use in the future creation of a promotional coupon, the static data may include one or a plurality of Coupon Trigger Metrics, one or a plurality of Coupon Issuance Control Parameters, a unique promotional campaign identifier, an authorization code, among others, the static data stored in the memory coupled to a GVP. The variable data may contain portions of printed indicia of promotional coupons or a unique promotional campaign identifier, an authorization code, among others, the variable data matched by a GVP to any variable data stored in the GVP's memory, the GVP combining portions of static and variable data to print a promotional coupon.

In another embodiment of the invention, a GVP transmitting an authorization code to a PCS, wherein the authorization code may be verified within the PCS, for example, to track promotional coupon redemption or retire a promotional coupon from issuance.

In another embodiment of the invention, the communications between the PCS and GVP is encrypted by a methodology known to the PCS and GVP, and the PCS and GVP processing incoming and outgoing communications according to the encryption method.

In another embodiment of the invention, the PCS is a player tracking system and its associated network.

In another embodiment of the invention, the PCS is the player tracking system and its associated network receiving gaming machine activity data based on the PCS's monitoring of the gaming machine, the PCS utilizing its link table in memory (disclosed above) to determine the unique network address of the GVP installed in the gaming machine, and the PCS sending information extracted from the activity data to the GVP installed in the gaming machine.

In another embodiment of the invention, the PCS is the player tracking system and its associated network receiving gaming machine activity data based on the PCS's monitoring of the gaming machine, the PCS processing the data according to procedures contained in its memory, the PCS determining if a promotional award has been triggered by the player activity, the PCS determining the type of award from a database in its memory, the PCS operating a procedure to create a validation identifier for the promotional coupon, the PCS signaling the GVP with data including the validation identifier and authorization to print the promotional coupon, the GVP printing such coupon, and the GVP signaling the PCS as to the completion of failure of its print job.

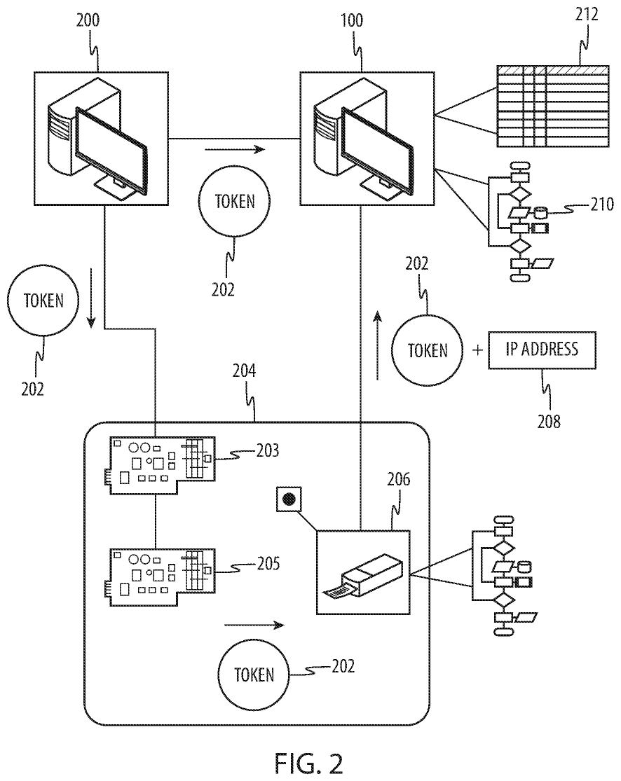

FIG. 2 is an illustration of an automatic method by which the PCS can pair a GVP's IP address to a gaming machine identifier in accordance with an exemplary embodiment of the present invention. In a PCS and its GVP network, there may be a plurality of GVPs, each with its own IP address, but it may be unknown to the PCS in which gaming machine a given GVP is installed. In FIG. 2, a cash-out voucher system controller 200 issues a unique special non-print ticket 202, herein termed a token, to a PCS 100 in addition to sending the token to each of the gaming machines, such as gaming machine 204, attached to the network. The gaming machine receives the token at a slot machine interface board 203 and passes the token to a gaming machine controller 205. The gaming machine controller passes the token to an associated GVP 206 which recognizes the token as the special non-print ticket token. The GVP, recognizing the token, passes the token to the PCS along with the GVP's network or IP address and logs that information into an internal memory or database. The PCS using procedures 212 can then form a database 212 linking GVP IP addresses to the gaming machine into which each GVP is installed. Once this relationship has been established, player activity data from a particular gaming machine can then be passed to the GVP installed in that same gaming machine.

In another embodiment of the invention, a multiplexer port or channel is used instead of two dedicated ports. In this variation, signaling related to promotional coupons and real-time printer activity monitoring is processed using a multiplexer port.

In another embodiment of the invention, the plurality of GVPs coupled to the PCS by a promotional network dedicated to the PCS-GVP connection, each GVP individually signaled by the PCS by means of a unique address.

In another embodiment of the invention, the plurality of GVP's coupled to the PCS by a promotional network dedicated to the PCS-GVP connection, each GVP is a sub-addressable device with the gaming machine available to the PCS.

In another embodiment of the invention, the PCS, is coupled to the GVP on a dedicated PCS-GVP network, creating a logical link between the GVP's unique network address and the gaming machine into which the GVP is installed for the purposes of correlating the GVP's gaming machine identifier, the link created by the GVP extracting the gaming machine number from voucher data signaling from the gaming machine controller on its primary communication port, the GVP signaling the PCS with both its unique address and the extracted gaming machine number, and the PCS storing the link in its memory.

In another embodiment of the invention, the PCS, is coupled to the GVP on a dedicated PCS-GVP network, creating a logical link between the GVP's unique network address and the gaming machine into which the GVP is installed for the purposes of correlating the GVP's gaming machine identifier, the link created by the GVP reading operator configurable gaming machine identifier address switches coupled to the GVP's processor, the GVP signaling the PCS with both its unique address and the configured gaming machine identifier address, and the PCS storing the link in its memory.

In another embodiment of the invention, the PCS, is coupled to the GVP on a dedicated PCS-GVP network, creating a logical link between the GVP's unique network address and the gaming machine into which the GVP is installed for the purposes of correlating the GVP's gaming machine identifier, the link created by the GVP is signaled as to its gaming machine identifier address by an operator controlled external device temporarily coupled to the GVP at the time the GVP is installed in a gaming machine, the GVP signaling the PCS with both its unique address and the operator controlled external device supplied gaming machine address, and the PCS storing the link in its memory.

In another embodiment of the invention, the GVP is temporarily coupled to an operator controlled external device at the time the GVP is installed in a gaming machine, the GVP receiving signaling as to the gaming machine identifier address of the gaming machine into which it is installed, and the GVP storing the gaming machine identifier address into memory coupled to its processor.

In another embodiment of the invention, the GVP signaling the PCS as to the gaming machine identifier address in which it is installed upon boot-up or when requested by the PCS.

In another embodiment of the invention, the GVP includes a procedure which, after boot-up, determines if a previously recorded gaming machine identifier exists in its memory, the identifier serving the purpose of signaling the GVP into which gaming machine it is installed, the procedure then signaling the PCS with the identifier.

In another embodiment of the invention, the GVP's unique network address is configured by operator configurable address switches coupled to the GVP's processor.

In another embodiment of the invention, the GVP's unique network address is assigned by the PCS, the GVP storing its address in memory for permanent use until a new address is assigned by the PCS.

In another embodiment of the invention, the GVP storing the identification of the gaming machine identification into which it is installed into memory coupled to the GVP's processor.

In another embodiment of the invention, the GVP's unique network address is a fixed value as a function of its hardware.

In another embodiment of the invention, the GVP includes a procedure which causes the GVP, after boot-up, to first receive cash-out voucher signaling from the gaming machine over its primary port, and the GVP then verifying that the gaming machine identifier is the same as the gaming machine identifier previously recorded in its memory as to which gaming machine the GVP is installed.

In another embodiment of the invention, the PCS broadcasts the time and date on a periodic basis to a GVP to which it is coupled, the GVP using the time and date data to synchronize its own internal clock.

In another embodiment of the invention, the GVP upon receiving cash-out voucher signaling from the gaming machine over its primary port, extracting the time and date from the data and using the time and date information to synchronize its internal clock.

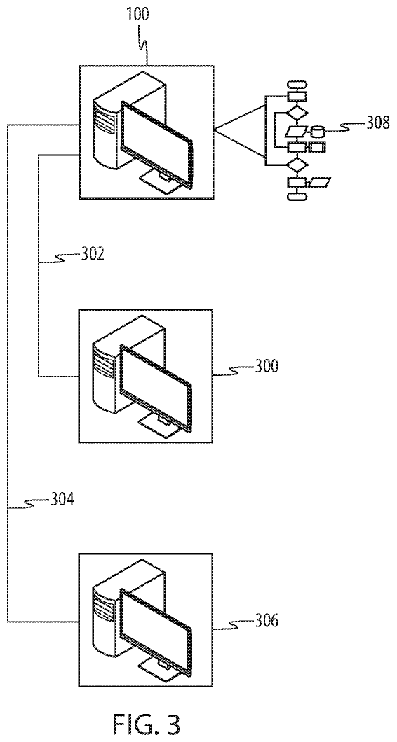

FIG. 3 is an illustration of a PCS 100 connected to other systems within a casino in accordance with an exemplary embodiment of the present invention. As shown in the example, the first connection 302 is to a point-of-sale system 300 for a property or casino in order to allow redemption approval when a player goes to cash in or redeem their coupon at a participating location. The other connection 304 shown is to an accounting system for the casino. The PCS, upon request, may use procedures 308 to export a report on all promotional activity, including coupons issued, redeemed and pending as well as data related to the real-time monitoring of printer activity, including promotional activity. This permits the property to perform all accounting reconciliation providing an audit trail. FIG. 3 is not intended to be all inclusive, and it is likely that there would be other casino systems to which the PCS would be connected.

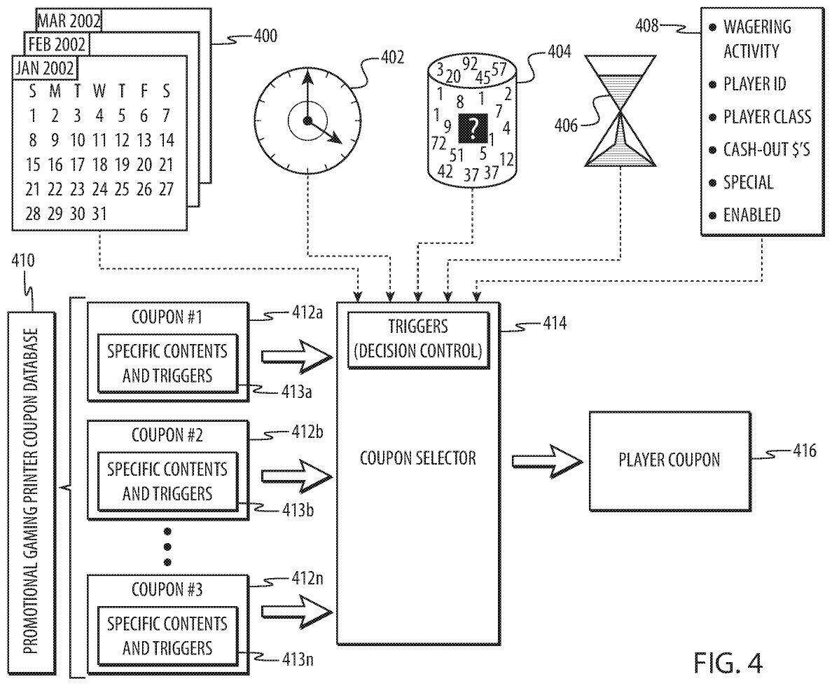

FIG. 4 is an illustration of the trigger matrix logic and procedures within a GVP, a PCS, or portions shared between the two, depending on where data processing of a PSP resides in accordance with an exemplary embodiment of the present invention. At the top of the diagram is an example of five different logical triggers utilized in the printer for initiating the promotional coupons. The five examples given are: date 400, time 402, frequency of issuing promotion 404, duration of play 406, and other parameters 408 such as wagering activity, player I.D., player class, cash-out amount, other special parameters, if a promotional data is enabled, among other such as amount of money in play, duration of the current session of play and the like. These triggers are examples of those previously discussed as “Coupon Trigger Metrics”. In the lower part of the diagram, the coupon database 410 stack is pictured. The stack of coupons are a plurality of pre-defined coupons, such as coupons 412a to 412n, which can printed anytime the set of trigger conditions to which they are associated, such as trigger conditions 413a to 413n, are satisfied. These trigger conditions can operate independently or in logical combination. The coupon selector logic module 414 shown is tasked with analyzing trigger information as it comes available and determine which coupon or coupons should be printed to produce a player coupon 416 issued to a player in response to the information. Additional processing, not shown, would occur in the PCS where the amount of coupons permitted in the campaign, an additional randomness of issue could be applied, and other possible global promotional campaign parameters or others previously discussed as “Coupon Issuance Control Parameters” would be checked before print authorization.

In another embodiment of the invention, the GVP receives player activity data of the gaming machine in which it is installed from the PCS, the GVP processes the data according to procedures (disclosed below) contained in its memory, the GVP determines if a promotional award has been triggered by the player activity and the type of the award, the GVP signaling the PCS as to various metrics of the triggered promotional award, the PCS processes the metrics of the promotional award, the PCS operates a procedure to create a validation identifier for the promotional coupon, the PCS signals the GVP with data including the validation identifier and authorization to print the promotional coupon, the GVP prints the coupon, and the GVP signals the PCS as to the completion or failure of its print job. In another embodiment of the invention, the PCS having received the signaling from the GVP as to the completion or failure of a promotional award print job (disclosed above), and the PCS creating a record in its memory as to the issuance of the promotional coupon.

In another embodiment of the invention, the PCS requests the GVP to send status as to the identifier of the promotional campaign static data file (described above) which resides in the GVP's memory, the PCS determining if the campaign identifier in the GVP is the version matches the identifier of the promotional campaign that the PCS is currently operating, and if not, the PCS sending new promotional campaign static data to the GVP which matches the promotional campaign which the PCS is operating.

In another embodiment of the invention, the communications between the PCS and GVP is encrypted by a methodology known to the PCS and GVP, and the PCS and GVP processing incoming and outgoing communications according to the encryption method.

In another embodiment of the invention, the PCS containing a record of promotional coupons issued by the GVPs in its memory, the PCS is coupled to a point-of-sale system, the PCS receiving signaling from the point-of-sale system when a coupon is redeemed as to the validation sequence of the coupon, the PCS checking the validity of the coupon against its records, the PCS signaling the point-of-sale system as to the validity of the coupon, and the PCS recording the redemption of the coupon in its memory.

FIG. 5 is an illustration of arbitration processing of a GVP in producing gaming vouchers and promotional coupons in accordance with an exemplary embodiment of the present invention.

As illustrated, the process for gaming vouchers begins 500 with the main communication handler 502. If data, such as a gaming voucher, exists (504) on a main port of the GVP, the system gets (506) the data from the main port and sets the printer to busy. If data does not exist on the main port, the process returns to the main communication handler.

The process for promotional coupons begins with the promo communication handler 508. If data, such as a promotional coupon, exists (510) on a second auxiliary or promo port of the GVP, the system gets (512) the data from the promo port and sets the printer to busy. If data does not exist on the promo port, the process returns to the promo communication handler.

If the printer is busy using any port, the data from the other port is queued (514).

The process continues with the system identifying (515) which data, gaming voucher data 516 or promotional coupon data 518, was received first. After identifying the data received first, the system processes the first data to generate a gaming voucher or promotional coupon, then returns to process the second data to generate a gaming voucher or promotional coupon.

An example of one arbitration scheme would be the GVP always giving priority to a cash-out voucher print job which comes from the gaming machine (on the primary port), and then queuing a coupon print job from the PCS (on the second auxiliary port) behind the voucher. Another example of an arbitration scheme would be the GVP receiving a coupon print job on its second auxiliary port, and then holding the coupon for a period of time awaiting arrival of a cash-out voucher on the primary port. If the cash-out voucher didn't arrive within a reasonable amount of time, the coupon could either be printed or canceled by the GVP. In addition to coupon print data, the GVP would receive certain static promotional campaign data on its second auxiliary port. The static data could include graphic icons which are necessary to print on the various coupons, portions of the coupons which would never change with an award, and optionally, a set of trigger conditions which would cause the GVP to trigger a coupon.

Once a determination is made on which data, voucher or coupon, to print first, the GVP prints (520) the selected coupon or voucher 522 and then prints the other coupon or voucher.

In another embodiment of the invention, a GVP includes the ways and means to utilize arbitration in the printing of vouchers and promotional coupons, the GVP coupled to a PCS and a cash-out voucher system, both systems coupled to each other, wherein the GVP using procedures contained in its memory and data or signaling from both or either system generates vouchers without delay and prior to any coupon is generated.

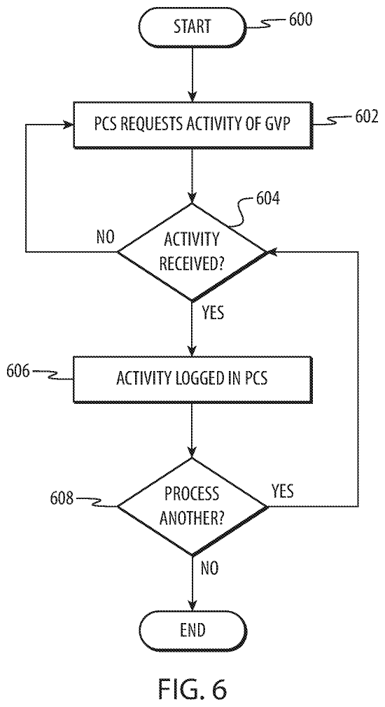

FIG. 6 is an illustration depicting the real-time monitoring of printer activities by a PCS in accordance with an exemplary embodiment of the present invention.

In this simplified example, the process begins (600) with the PCS requesting (602) activity from a GVP. After the PCS signals one or multiple GVPs for the printer activity, each GVP responds to the signaling by providing (604) the requested activity. The PCS may then log (606) each activity in its internal memory or database, process, or forward that log to another host system such as an accounting system. The process may continue (608) if there are additional requests for activity from the PCS.

If no activity is received, the PCS may also log that information in its internal memory or database, or forward that log to another host system such as an accounting system.

An example of the printer activities requested from the PCS and reported by a GVP may include any promotional coupon activity performed by the GVP including any “Coupon Trigger Metrics”, any “Coupon Issuance Control Parameter” both of which are disclosed below, number of coupons printed, number of times a template was used to produce a coupon, among others.

Another example of the printer activities requested from the PCS and reported by a GVP may include any voucher activity performed by the GVP including a cash-out request by a player, number of vouchers printed, and number of times a template was used to produce a voucher, among others.

Another example of the printer activities requested from the PCS and reported by a GVP may include other printer activity such as any printing error, if the printer is busy, if the is paper out; low; or jammed, an abnormal temperature or voltage condition, a data error, a memory error, whether the printer is online or offline, if the printer is in sleep mode, if the printer door is open, any power resets, historical data on a print head, if a print job failed, or if a print job completed, among others. Additionally, the real-time printer activities may include a date/time stamp or a GVP unique ID, among others.

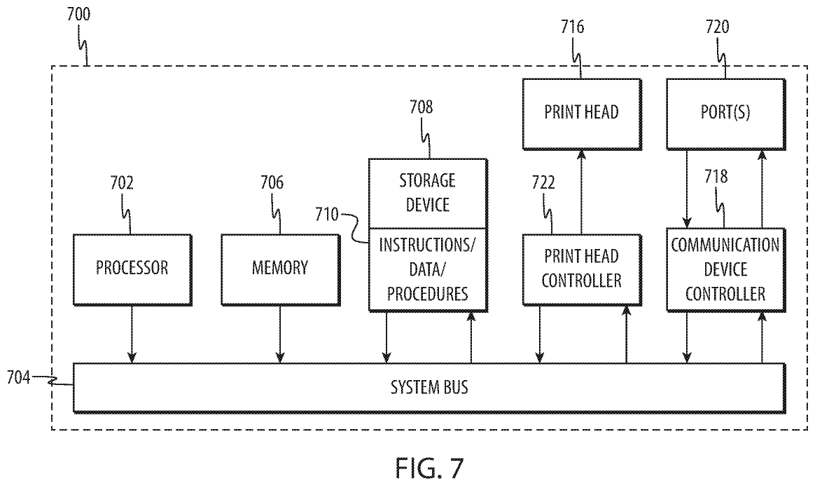

FIG. 7 is a diagram of a GVP and components thereof in accordance with an exemplary embodiment of the present invention. A component or plurality of components shown in FIG. 7 are optional.

A GVP 700 includes a processor 702, operatively coupled via a system bus 704 to a memory 706. The processor is further operatively coupled via the system bus to a storage device 708. Program instructions and data 710 implementing the procedures as described herein for a GVP are stored in the storage device until the processor retrieves the program instructions and stores them in the memory. The processor then executes the program instructions stored in the memory to implement any of the features of the GVP as described herein.

The processor is further coupled via the system bus to a communication device controller 718 that is coupled to one or more communication ports 720. The GVP uses the communication device controller and communication ports to transmit and receive control signals from external hosts and devices as described herein.

The processor is further coupled via the system bus to a printer head controller 722 that is coupled to a printer head 716. The GVP uses the printer head to print vouchers and coupons as described herein.

Although the GVP has been described in terms of a computing system having a processor, memory and instructions executed by the processor, it is to be understood that the foregoing has been presented by way of example and not of limitation. It is to be understood that a GVP may also be implemented using hardwired circuitry or the like, programmable components or the like, or any combination thereof.

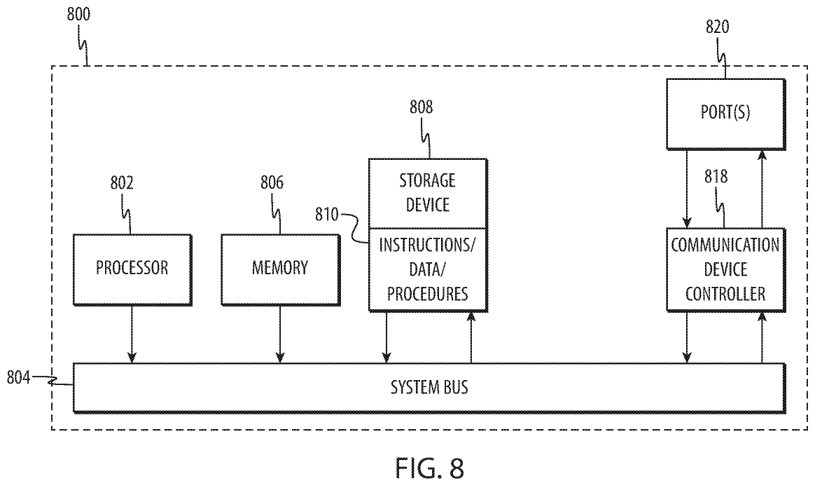

FIG. 8 is a diagram of a PCC and components thereof in accordance with an exemplary embodiment of the present invention. A component or plurality of components shown in FIG. 8 are optional.

A PCS 800 includes a processor 802, operatively coupled via a system bus 804 to a memory 806. The processor is further operatively coupled via the system bus to a storage device 808. Program instructions and data 810 implementing the procedures as described herein for a PCS are stored in the storage device until the processor retrieves the program instructions and stores them in the memory. The processor then executes the program instructions stored in the memory to implement any of the features of the PCS as described herein.

The processor is further coupled via the system bus to a communication device controller 818 that is coupled to one or more communication ports 820. The GVP uses the communication device controller and communication ports to transmit and receive control signals from external hosts and devices as described herein.

Although the PCS has been described in terms of a computing system having a processor, memory and instructions executed by the processor, it is to be understood that the foregoing has been presented by way of example and not of limitation. It is to be understood that a PCS may also be implemented using hardwired circuitry or the like, programmable components or the like, or any combination thereof.

Although the invention has been described in certain specific embodiments, many additional modifications and variations would be apparent to those skilled in the art. It is therefore to be understood that this invention may be practiced otherwise than as specifically described. Thus, the present embodiments of the invention should be considered in all respects as illustrative and not restrictive, the scope of the invention to be determined by any claims supportable by this application and the claims' equivalents rather than the foregoing description.

1-61. (canceled)

62. A casino system, comprising:
at least one server;
a printer; and
an electronic gaming machine in communication with the at least one server and the printer, the electronic gaming machine configured to:
determine a first value representing funds available for wagering based upon a last gameplay action; and
determine to initiate a cash-out event;
wherein the printer responds to the cash-out event by providing a ticket associated with a second value received from the at least one server.

63. The casino system of claim 62, wherein the at least one server determines the second value.

64. The casino system of claim 62, wherein the first value is an amount of a currency.

65. The casino system of claim 64, wherein the second value is different from the amount of the currency.

66. The casino system of claim 62, wherein the ticket comprises a coupon.

67. The casino system of claim 62 1, wherein the at least one server determines the second value based on a player identifier.

68. The casino system of claim 62, wherein the at least one server is operable to check validity of the ticket.

69. A casino system, comprising:
at least one server;
a printer; and
an electronic gaming machine in communication with the at least one server and the printer, the electronic gaming machine configured to determine to initiate a cash-out event associated with a first value; wherein:
the at least one server responds to the cash-out event by instructing the printer to provide a ticket associated with a second value.

70. The casino system of claim 69, wherein the at least one server determines a network address for the printer using a gaming machine identifier for the electronic gaming machine that is associated with the printer.

71. The casino system of claim 70, wherein the at least one server instructs the printer using the network address.

72. The casino system of claim 69, wherein the at least one server maintains a record of the ticket.

73. The casino system of claim 69, wherein the printer notifies the at least one server that the ticket is provided.

74. The casino system of claim 69, wherein the ticket includes a validation identifier.

75. The casino system of claim 69, wherein the printer notifies the at least one server of a failure to provide the ticket.

76. A casino system, comprising:
at least one server;
a value output device; and
an electronic gaming machine in communication with the at least one server and the value output device, the electronic gaming machine configured to determine to instruct the value output device to provide a first ticket; wherein:
the value output device provides a second ticket that is different from the first ticket according to an instruction received from the at least one server.

77. The casino system of claim 76, wherein the value output device comprises a voucher printer.

78. The casino system of claim 76, wherein the printer determines that the instruction to provide the second ticket preempts providing the first ticket.

79. The casino system of claim 76, wherein the at least one server receives a notification when the second ticket is redeemed.

80. The casino system of claim 76, wherein the value output device comprises:
a first port configured to communicate with the electronic gaming machine; and
a second port configured to communicate with the at least one server.

81. The casino system of claim 76, wherein the second ticket is unrelated to the first ticket.
